(19) United States
(12) Patent Application Publication
(10) Pub. No.: US 2022/0365673 A1
(43) Pub. Date: Nov. 17, 2022

(54) NON-INTRUSIVE SHARED PROCESSING METHOD AND SYSTEM FOR POP-UP WINDOW

(71) Applicant: ADLINK Technology Inc., Taoyuan City (TW)

(72) Inventors: CHIEN-CHUNG LIN, Taoyuan City (TW); WEI-JYUN TU, Taoyuan City (TW); YU-YEN CHEN, Taoyuan City (TW)

(21) Appl. No.: 17/405,745

(22) Filed: Aug. 18, 2021

(30) Foreign Application Priority Data
May 11, 2021 (TW) 110116945

(51) Int. Cl. G06F 3/0488; G06F 3/0484; G06F 3/0481; G06K 9/20

(52) U.S. Cl. CPC G06F 3/04886; G06F 3/04842; G06F 3/04817; G06K 9/2054; G06K 2209/01

(57) ABSTRACT

A non-intrusive shared processing method for pop-up window is applied for inhibiting or closing the pop-up window on the display device. The method includes the following steps: a non-intrusive terminal device publishing the pop-up window data to an information theme in a communication interface; a central processing device subscribing to the information theme to receive the pop-up window data and generating a decision data corresponding to the pop-up window data, and publishing the decision data to the information theme; and, the non-intrusive terminal device receiving the decision data from the information theme and inhibiting or closing the pop-up window of the display device according to the decision data. Therefore, the method of the present invention can automatically transmit the information and solution of the pop-up window to other equipments with the same type through subscription/publishing mechanism, thereby decreasing the process time.

### BACKGROUND OF THE INVENTION

### 1. Field of the Invention

The present invention relates to a non-intrusive shared processing method and a non-intrusive shared processing system for pop-up window, and more particularly, to a non-intrusive shared processing method and a non-intrusive shared processing system with capability of automatically detecting, closing and inhibiting the pop-up window of equipment.

### 2. Description of the Prior Art

With the rapid development of industry, equipment in many factories is gradually becoming automated and intelligent. The equipment usually goes with the display device, and the equipment displays current production schedule or various parameters on the display device, so that operators can examine the operational status of the equipment.

In the prior art, the equipment reminds operators by a signal light when the parameters or values of the equipment exceed the warning threshold. In other word, the operators need to standby beside the equipment to deal with the emergency or abnormal event of the equipment. Furthermore, when the production parameters or values of the equipment need to be recorded, the operators also have to transcribe them periodically on site. The current technology and products for capturing the screen image and analyzing the data on screen image have been developed for solving the problem related to labor costs of traditional equipment, so as to automatically monitor the operating status of the equipment.

However, the pop-up windows of notifying or warning for peripheral device or unit configured in the equipment sometimes show up on the display device, for example, the notification window for notifying that the charging device has been charged completely, the notification window for notifying that the air supply device has been opened, and the warning window for notifying that 30% remaining materials in the feeding tray. The pop-up windows may cover the production parameters or the data those need to be detected on the display device, so that the system cannot recognize the data and result in abnormal state. The current solutions comprises that the operators manually close the pop-up windows on the equipment on site, or the operators remotely control the equipment to close the pop-up windows by the intrusive controlling module installed in the equipment. Due to a large amount of equipment in large factories, even hundreds of them, if each of the equipment appears a pop-up window, the operators need to close the pop-up windows one by one and it would reduce the efficiency and increase the cost. Furthermore, if each of the equipments installs the intrusive controlling module, it would cause additional loadings to the equipments to reduce the production efficiency. In addition, the same equipment may encounter the pop-up windows of the same type, and the operators still have to close the pop-up windows manually or remotely one by one, thereby reducing the efficiency.

Therefore, it is necessary to develop a new automatically processing mechanism for the pop-up windows to solve the problems in the prior art.

### SUMMARY OF THE INVENTION

Therefore, a scope of the present invention is to provide a non-intrusive shared processing method to solve the problems in the prior art.

In one embodiment of the present invention, the non-intrusive shared processing method is configured to inhibit or close the pop-up window on the display device. The non-intrusive shared processing method for pop-up window comprises the following steps: a first non-intrusive terminal device publishing the pop-up window data of the pop-up window to an information theme in a communication interface; a central processing device subscribing to the information theme in the communication interface to receive the pop-up window data and generating a decision data corresponding to the pop-up window data, and publishing the decision data to the information theme in the communication interface; and, the first non-intrusive terminal device receiving the decision data from the information theme in the communication interface, and inhibiting or closing the pop-up window on the display device according to the decision data

Wherein, the non-intrusive shared processing method for pop-up window further comprises the following steps: the first non-intrusive terminal device capturing a screen image of the display device and detecting the pop-up window by comparing the screen image with a preset screen image; and, the first non-intrusive terminal device analyzing the pop-up window to generate the pop-up window data.

Wherein, the step of the first non-intrusive terminal device capturing the screen image of the display device and detecting the pop-up window by comparing the screen image with a preset screen image further comprises the following steps: the first non-intrusive terminal device capturing the screen image of the display device; the first non-intrusive terminal device determining whether the preset screen image exists or not; if the preset screen image does not exist, the first non-intrusive terminal device setting the screen image as the preset screen image; and, if the preset screen image exists, the first non-intrusive terminal device detecting the pop-up window by comparing the screen image with the preset screen image.

Wherein, the step of the first non-intrusive terminal device analyzing the pop-up window to generate the pop-up window data further comprises the following steps: the first non-intrusive terminal device analyzing and calculating the pop-up window by an algorithm to generate a button data in the pop-up window data, wherein the button data comprises a button contour and a button position; and, the first non-intrusive terminal device analyzing the button data by Optical Character Recognition analysis to generate a button character in the button data.

Furthermore, the non-intrusive shared processing method for pop-up window further comprises the following steps: the first non-intrusive terminal device comparing the pop-up window data with a plurality of history pop-up window data stored in a first database to determine whether the pop-up window data conforms with a first history pop-up window data in the plurality of history pop-up window data, wherein the first database stores a plurality of history decision data, and the plurality of history pop-up window data are respectively corresponding to the plurality of history decision data; and, if the pop-up window data conforms with a first history pop-up window data, the first non-intrusive terminal device inhibiting or closing the pop-up window according to the history decision data corresponding to the first history pop-up window data.

Wherein, the step of the central processing device subscribing to the information theme in the communication interface to receive the pop-up window data and generating the decision data corresponding to the pop-up window, and publishing the decision data to the information theme in the communication interface further comprises the following steps: the central processing device receiving the pop-up window data to generate a plurality of solutions corresponding to the pop-up window data; selecting one of the solutions as the decision data according to the pop-up window data of the pop-up window; and, the central processing device publishing the decision data to the information theme in the communication interface.

Wherein, the non-intrusive shared processing method for pop-up window further comprises the following steps: a second non-intrusive terminal device subscribing to the information theme in the communication interface; and, the second non-intrusive terminal device receiving and storing the pop-up window data and the decision data into a second database from the information theme of the communication interface.

Another scope of the present invention is to provide a non-intrusive shared processing system for pop-up window to solve the problems in the prior art.

According to one embodiment of the present invention, the non-intrusive shared processing system for pop-up window is configured to inhibit or close a pop-up window of a display device. The non-intrusive shared processing system for pop-up window comprises a communication interface and a first non-intrusive shared terminal device. The communication interface comprises an information theme. The information theme is configured to store a pop-up window data of the pop-up window and a decision data corresponding to the pop-up window. The first non-intrusive shared terminal device is coupled to the communication interface and the display device, and subscribes to the information theme in the communication interface. The first non-intrusive shared terminal device further comprises an image capturing module, an image analyzing module, a transmission module and a processor. The image capturing module is configured to capture a screen image of the display device. The image analyzing module is coupled to the image capturing module and storing a preset screen image. The image analyzing module is configured for analyzing the screen image and the preset screen image to detect the pop-up window and generate the pop-up window data. The transmission module is configured to publish the pop-up window data to the information theme and receive the decision data from the information theme. The processor is coupled to the transmission module and the display device. The processor controls the transmission module to publish the pop-up window and to receive the decision data, and the processor inhibits or closes the pop-up window on the display device according to the decision data.

Wherein, the image analyzing module sets the screen image as the preset screen image when the preset screen image does not exist.

Wherein, the image analyzing module analyzes the pop-up window by an algorithm and Optical Character Recognition to generate a button character in the pop-up window data, wherein the button data comprises a button contour, a button position, and a button character.

Wherein, the first non-intrusive terminal device comprises a first database coupled to the processor. The first database is configured to store a plurality of the history pop-up window data and a plurality history decision data. The history pop-up window data are respectively corresponding to the history decision data. When the pop-up window data generated by the image analyzing module conforms with a first history pop-up window data in the plurality of history pop-up window data, the processor inhibits or closes the pop-up window on the display device according to the history decision data corresponding to the first history pop-up window.

Wherein, the non-intrusive shared processing system for pop-up window further comprises a second non-intrusive terminal device coupled to the communication interface and subscribing to the information theme of the communication interface. The second non-intrusive terminal device comprises a second database. The second non-intrusive terminal device receives the pop-up window data and the decision data from the information theme, and stores the pop-up window data and the decision data into the second database.

Wherein, the non-intrusive shared processing system of the pop-up window further comprises a central processing device coupled to the communication interface and subscribing to the information theme of the communication interface. The central processing device receives the pop-up window data from the information theme to generate the decision data corresponding to the pop-up window, and publishes the decision data into the information theme of the communication interface.

In one embodiment, the central processing device generates a plurality of solutions corresponding to the pop-up window data, and sets one of the solutions selected by a user as the decision data.

In another embodiment, the central processing device comprises an analyzing module. The central processing device generates a plurality of solutions corresponding to the pop-up window data according to the pop-up window data, and the analyzing module selects one of the solutions as the decision data according to pop-up window data.

In one embodiment, the non-intrusive shared processing system for pop-up window further comprises a third non-intrusive terminal device coupled to the communication interface and subscribing to the information theme of the communication interface. The third non-intrusive terminal device receives the pop-up window data from the information theme to generate the decision data corresponding to the pop-up window, and publishes the decision data into the information theme of the communication interface.

In summary, the non-intrusive shared processing method and system of this invention can automatically detect the pop-up windows of the equipment, and the operators can remotely provide the solutions through the communication interface, thereby reducing the labor costs. In addition, the non-intrusive shared processing method and system for pop-up window of this invention can automatically inhibit the pop-up window generated by the equipment through the non-intrusive terminal device, thereby reducing the labor costs and increasing the production efficiency. Furthermore, the non-intrusive shared processing method and system of the pop-up window of this invention can automatically detect the pop-up window and compare it with the processed pop-up window through the storage device, thereby increasing the detecting efficiency and reducing the time costs. Moreover, the non-intrusive shared processing method and system for pop-up window of the present invention can automatically transmit the data of pop-up window and the solutions to other equipments of the same type by subscribing and publishing, thereby reducing the processing time of the operators, increasing the efficiency and lowering the cost. In addition, the non-intrusive shared processing system for pop-up window of the present invention can also directly process the pop-up window on the equipment, thereby increasing the convenience and efficiency.

### BRIEF DESCRIPTION OF THE APPENDED DRAWINGS

FIG. 1 is a flow chart illustrating a non-intrusive shared processing method for pop-up window according to an embodiment of the present invention.

FIG. 2 is a function block diagram illustrating a non-intrusive shared processing system for pop-up window according to an embodiment of the present invention.

FIG. 3 is a function block illustrating the non-intrusive terminal device according to FIG. 2.

FIG. 4 is a flow chart illustrating the non-intrusive shared processing method for pop-up window according to FIG. 1.

FIG. 5 is a flow chart illustrating the non-intrusive shared processing method for pop-up window according to FIG. 1.

FIG. 6 is a flow chart illustrating the non-intrusive shared processing method for pop-up window according to FIG. 1.

FIG. 7 is a flow chart illustrating a non-intrusive shared processing method for pop-up window according to an embodiment of the present invention.

FIG. 8 is a function block diagram illustrating a non-intrusive shared processing system for pop-up window according to an embodiment of the present invention.

FIG. 9 is a function block diagram illustrating a non-intrusive shared processing system for pop-up window according to another embodiment of the present invention.

FIG. 10 is a function block diagram illustrating a non-intrusive shared processing system for pop-up window according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of the present specification, the terminologies “in an embodiment”, “in another embodiment”, or “in some embodiments” means that the specific feature, structure, material or characteristic of the present embodiment is involved in at least one embodiment of the present invention. In the description of the present specification, the schematic representation of the mentioned terminologies does not necessarily refer to the same embodiment. Furthermore, the described specific feature, structure, material or characteristic can be involved in any one or more embodiments in a proper way.

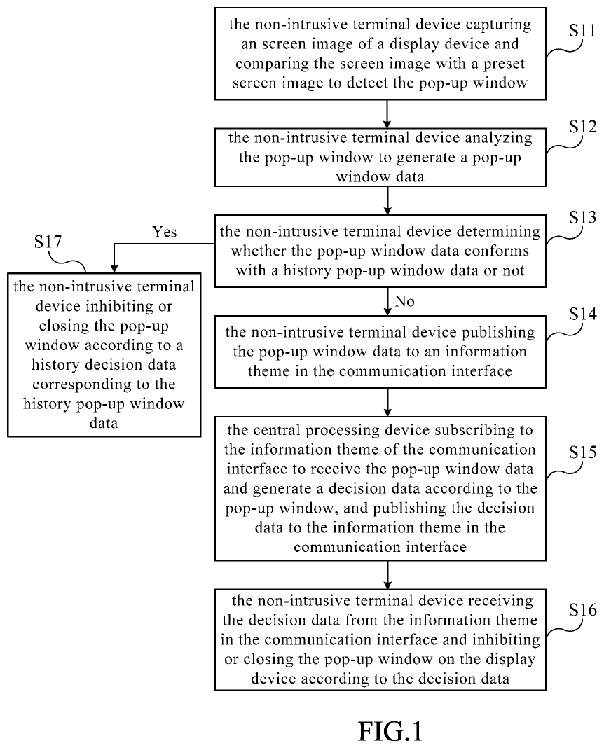

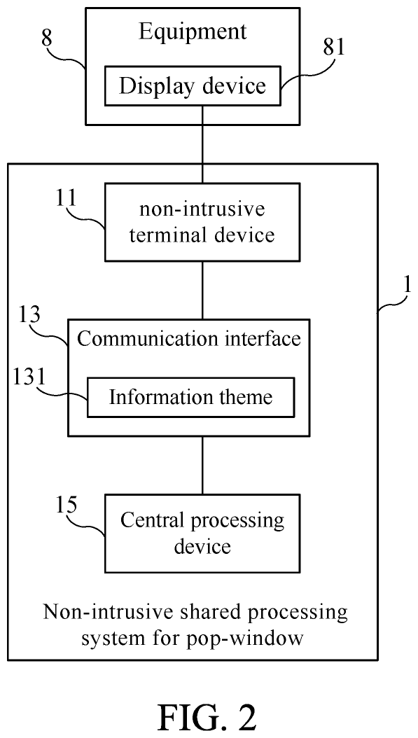

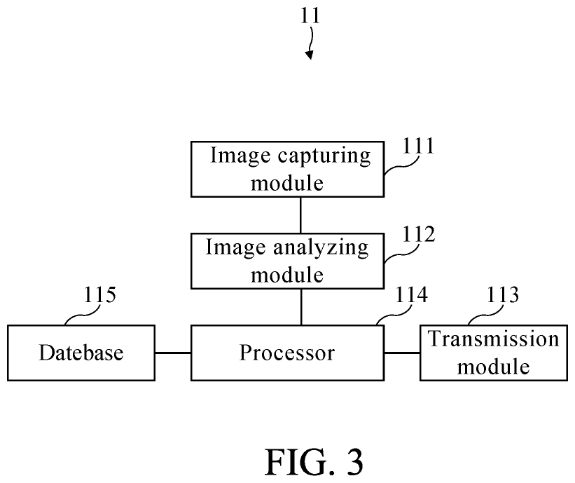

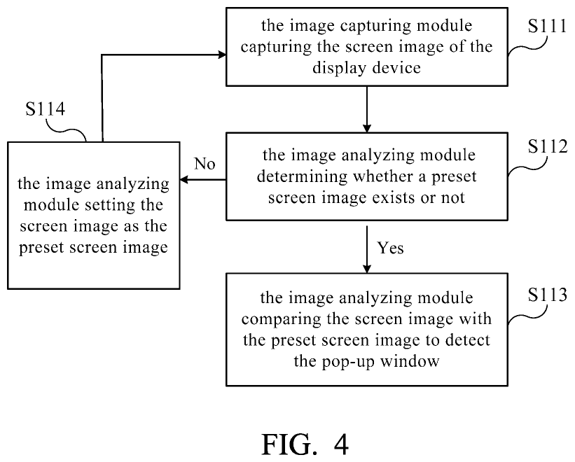

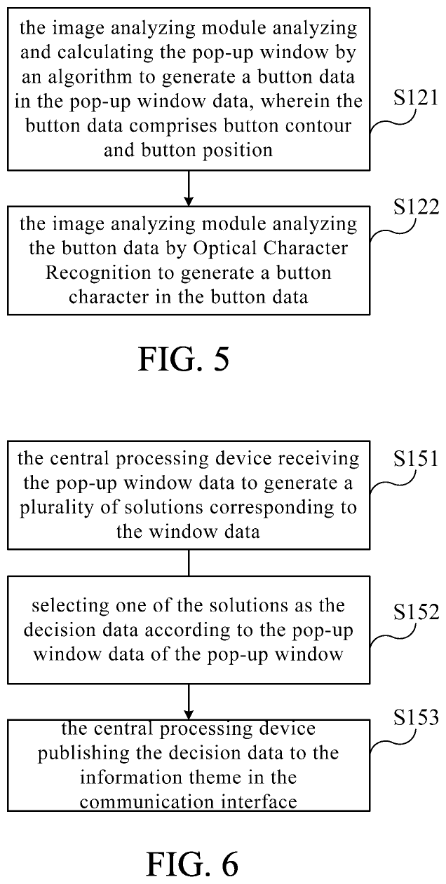

Please refer to FIG. 1 to FIG. 6. FIG. 1 is a flow chart illustrating a non-intrusive shared processing method for pop-up window according to an embodiment of the present invention. FIG. 2 is a function block diagram illustrating a non-intrusive shared processing system for pop-up window according to an embodiment of the present invention. FIG. 3 is a function block illustrating the non-intrusive terminal device according to FIG. 2. FIG. 4 is a flow chart illustrating the non-intrusive shared processing method for pop-up window according to FIG. 1. FIG. 5 is a flow chart illustrating the non-intrusive shared processing method for pop-up window according to FIG. 1. FIG. 6 is a flow chart illustrating the non-intrusive shared processing method for pop-up window according to FIG. 1. The non-intrusive shared processing method for pop-up window in FIG. 1, FIG. 4, FIG. 5 and FIG. 6 can be executed by the non-intrusive shared processing system 1 for pop-up window in FIG. 2 and the non-intrusive shared processing system 11 for pop-up window in FIG. 3. As shown in FIG. 1, in this embodiment, the non-intrusive shared processing method for pop-up window comprises the following steps: step S11: the non-intrusive terminal device 11 capturing an screen image of a display device 81 and comparing the screen image with a preset screen image to detect the pop-up window; step S12: the non-intrusive terminal device 11 analyzing the pop-up window to generate a pop-up window data; step S13: the non-intrusive terminal device 11 determining whether the pop-up window data conforms with a history pop-up window data or not; if the pop-up window data conforms with a history pop-up window data, in step S17: the non-intrusive terminal device 11 inhibiting or closing the pop-up window according to a history decision data corresponding to the history pop-up window data; if the pop-up window data does not conform with a history pop-up window data, in step S14: the non-intrusive terminal device 11 publishing the pop-up window data to an information theme 131 in the communication interface 13; step S15: the central processing device 15 subscribing to the information theme of the communication interface 13 to receive the pop-up window data and generate a decision data according to the pop-up window, and publishing the decision data to the information theme 131 in the communication interface 13; and, step S16: the non-intrusive terminal device 11 receiving the decision data from the information theme 131 in the communication interface 13 and inhibiting or closing the pop-up window on the display device 81 according to the decision data.

In this embodiment, the non-intrusive shared processing system 1 for pop-up window comprises the non-intrusive terminal device 11, the communication interface 13, and the central processing device 15. The non-intrusive terminal device 11 is coupled to the communication interface 13, and the communication interface 13 is coupled to the central processing device 15. Furthermore, the non-intrusive terminal device 11 is coupled to the display device 81. In practice, the display device 81 can be a display screen of the equipment 8. The non-intrusive terminal device 11 can communicate with the display device 81, and the non-intrusive terminal device 11 can communicate with the central processing device 15 through the communication interface 13.

In practice, the communication interface 13 can be a middleware connected with the operating system. The communication interface 13 can generate an information stream comprising a plurality of information themes. The information themes can comprise the data about pop-up windows. The non-intrusive terminal device 11 can establish the information theme 131 and publish the information theme 131 with the pop-up window data to the communication interface 13 when the transmission module 113 of the non-intrusive terminal device 11 publishes the pop-up window data to the communication interface 13. Furthermore, the information theme 131 can comprise a decision data corresponding to the pop-up window. The non-intrusive terminal device 11 can receive the decision data from the information theme, and inhibit or close the pop-up window on the display device 81 according to the decision data. The decision data can be the order or the means for processing the pop-up window to prevent the display device 81 of the equipment from being covered by the pop-up window.

In this embodiment, the non-intrusive terminal device 11 comprises an image capturing module 111, an image analyzing module 112, a transmission module 113, a processor 114, and a database 115. The image capturing module 111 is configured to capture a screen image of the display device 81. The image analyzing module 112 is connected to the image capturing module 111 and store a preset screen image. The image analyzing module 112 is configured to analyze the screen image with the preset screen image for detecting the pop-up window, and to generate the pop-up window data by analyzing the pop-up window. The transmission module 113 is configured to publish the pop-up window data to the information theme 131, and to receive the decision data from the information theme 131. The processor 14 is coupled to the transmission module 113 and the display device 81. The processor 14 controls the transmission module 113 to publish the pop-up window and to receive the decision data, and the processor 14 inhibits or closes the pop-up window on the display device 81 according to the decision data. The database 115 is connected to the processor 114. The database 115 is configured to store a plurality of history pop-up window data and a plurality of history decision data. The history pop-up window data are respectively corresponding to the history decision data. In practice, the image capturing module 111 can be an image capturing chip. The image analyzing module 112 can be an image analyzing chip. The transmission module 113 can be a transceiver. The processor 14 can be a central processing unit (CPU), and the database 115 can be a hard disk.

In step S11 of FIG. 1, the image capturing module 111 of the non-intrusive terminal device 11 captures the screen image of the display device 81, and the image analyzing module 112 compares the screen image with the previous screen image to detect the pop-up window of the equipment. As shown in FIG. 4, the step of the non-intrusive terminal device 11 detecting the pop-up window of the equipment further comprises: step S111: the image capturing module 111 capturing the screen image of the display device; step S112: the image analyzing module 112 determining whether a preset screen image exists or not; if the preset screen image does not exist, in step S114: the image analyzing module 112 setting the screen image as the preset screen image; and, if the preset screen image exists, in step S113: the image analyzing module 112 comparing the screen image with the preset screen image to detect the pop-up window.

In practice, the image capturing module 111 can capture the screen images of the display device 81 of the equipment 8 at different time, and the image analyzing module 112 can store the preset screen image. The preset screen image can be the screen image of the equipment in the normal operation. The image analyzing module 112 can compare two adjacent screen images by image differential method (such as image binarization), and detect the pop-up window of the display device 81 of the equipment 8 by image erosion, structural elements, contour calculation, etc. If the image differential value analyzed by the image analyzing module 112 is 0, the image analyzing module 112 can store the present screen image as the preset screen image, so as to be compared with the next screen image captured by the image capturing module 111. If the image differential value analyzed by the image analyzing module 112 is not 0, the image analyzing module 112 can detect the pop-up window of the display device 81 according to the image differential method. In addition, when the equipment starts at the first time or reboots, the preset screen image does not exist in the non-intrusive terminal device 11. At this time, the image analyzing module 112 can set the first screen image captured by the image capture module 111 as the preset screen image.

In step S12 of FIG. 1, when detecting the pop-up window on the display device, the image analyzing module 112 generates the pop-up window data according to the pop-up window. In practice, the pop-up window data comprises size, character, button, graphics, patterns, etc. Because the equipment may generate the pop-up window comprising button to be determined, the step of the non-intrusive terminal device 11 generating the pop-up window data further comprises the following steps as shown in FIG. 5: step S121: the image analyzing module 112 analyzing and calculating the pop-up window by an algorithm to generate a button data in the pop-up window data, wherein the button data comprises button contour and button position; and, step 122: the image analyzing module 112 analyzing the button data by Optical Character Recognition to generate a button character in the button data.

In practice, the image analyzing module 112 can obtain the button contour and the button position in the pop-up window data by Canny edge detector, Douglas-Peucker algorithm, or other algorithm. Moreover, the image analyzing module 112 can recognize the button character by Optical Character Recognition (OCR). In addition, the image analyzing module 112 can calculate the position of the pop-up window on the display device 81 and the characters on the pop-up window. It should be noted that the types of the image capturing module 111 and the image analyzing module 112 are not limited to those mentioned above, and the image capturing module 111 and the image analyzing module 112 can be integrated in the same chip.

In step S13 of FIG. 1, after the image analyzing module 112 generates the pop-up window data of the pop-up window, the processor 114 compares the pop-up window data with the history pop-up window data stored in the database 115 and determines whether the pop-up window data conforms with the history pop-up window data. In practice, the history pop-up window data and history decision data may be the previous pop-up window data and the corresponding solutions. The database 115 can pre-store the pop-up window data of various pop-up windows and the decision data corresponding to these pop-up windows, and also can receive and store the pop-up window data and the decision data from the subscribed information theme 131 in the communication interface by the transmission module 113. The processor 114 can compare the pop-up window data generated by the image analyzing module 112 with the history pop-up window data by the algorithm (such as template comparison, feature invariant moments, feature vectors, distance convolution neural network classifiers, etc.)

In step S17 of FIG. 1, if the pop-up window data generated by the image analyzing module 112 conforms to a first history pop-up window data in history pop-up window data, it means that the pop-up window currently shown on the display device 81 of the equipment 8 has appeared before and there is a corresponding solution for the pop-up window. At this time, the processor 114 finds out the history decision data corresponding to the first history pop-up window data from the database 115 for inhibiting or closing the pop-up window on the display device 81. Therefore, the non-intrusive shared processing method and system for pop-up window of the present invention can automatically detect and compare the pop-up window with those processed before by the storage device, thereby increasing the detecting efficiency and reducing the time costs.

In step S14 of FIG. 1, if the pop-up window data generated by the image analyzing module 112 does not conform to any of the history pop-up window data, it means that the pop-up window currently shown on the display device 81 of the equipment 8 is a new pop-up window without solution yet. At this time, the processor 114 controls the transmission module 113 to publish the pop-up window data of the current pop-up window to the communication interface 13. In practice, the transmission method of the transmission module 113 can be, but not limited to, transmission protocols of EdgeSDK, DDS, ROS/ROS2, MQTT, TCP/UDP, etc. The processor 114 can establish an information theme 131 and publish the information theme 131 comprising the pop-up window data to the communication interface 13 at the same time.

In step S15 of FIG. 1, when receiving the pop-up window without solution yet from the information theme 131 of the communication interface 13, the central processing device 15 generates and publishes a decision data corresponding to the pop-up window data to the information theme 131 of the communication interface 13. Furthermore, as shown in FIG. 6, the non-intrusive shared processing method for pop-up window further comprises the following step: step S151: the central processing device 15 receiving the pop-up window data to generate a plurality of solutions corresponding to the window data; step S152: selecting one of the solutions as the decision data according to the pop-up window data of the pop-up window; and, step S153: the central processing device 15 publishing the decision data to the information theme 131 in the communication interface 13.

In practice, the central processing device 15 can be central controlling computer. The central processing device 15 can pre-store the plurality of solutions, and each of the solutions can comprise different processing means and processing data. For example, the solutions can be closing the pop-up window, minimizing the pop-up window or hiding the pop-up window. In practice, the central processing device 15 further comprises a central processing chip and a displayer. In step S151 of FIG. 6, when the central processing device 15 obtains the pop-up window data, the central processing chip rebuilds the pop-up window on the displayer according to the pop-up window data, and rebuilds the solutions in the form of buttons on one side of the pop-up window. Moreover, as shown in step 152 of FIG. 6, the operators can examine the pop-up window through the displayer of the central processing device 15, and select or click on the buttons on the side of the reconstruction pop-up window according to the pop-up window data to decide the solution of the pop-up window data. For example, the central processing device 15 makes the processing data of pop-up window hidden as the decision data when the operators select the button of hiding the pop-up window.

The operators can not only select one of the solutions for the pop-up window from the pre-stored solutions but also define the solution for the pop-up window by themselves. After receiving the pop-up window without solution yet from the communication interface, the central processing device 15 can rebuild the buttons of the pop-up window on the displayer according to the button data in the pop-up window data, and the central processing device 15 can generate decision data corresponding to the pop-up window through, but not limited to, the mouse event. In practice, the operators can click one of the button of the pop-up window by the mouse according to the type and information of the pop-up window. At this time, the analyzing and processing chip in the central processing device 15 can record the position coordinate of the mouse and the clicking location on the displayer by the mouse for generating the decision data.

The decision data generated by the central processing device 15 can be determined by the operators, but also in other ways. In one embodiment, the central processing device 15 comprises an analyzing module. The central processing device 15 generates a plurality solutions corresponding to the pop-up window data, and the analyzing module selects one of the solutions as the decision data according to the pop-up window data. In practice, the analyzing module can be a machine learning chip and pre-store a decision module. The analyzing module calculates the solution corresponding to the pop-up window according to the pop-up window data and decision module after the central processing device 15 receives the pop-up window data. In another embodiment, the central processing device comprises a timer. The central processing chip in the central processing device 15 selects a preset solution as the decision data if the central processing device displays the pop-up window for a specific period without receiving the solution.

In step S153 of FIG. 6, after generating the decision data corresponding to the pop-up window, the central processing device 15 publishes the decision data into the information theme 131 of the communication interface 13.

In step S16 of FIG. 6, after the central processing device 15 publishes the decision data into the information theme 131 of the communication interface 13, the processor 114 of non-intrusive terminal device 11 can control the transmission module 113 to obtain the decision data corresponding to the pop-up window from the information theme 131. The processor 114 can control the screen of the display device 81 of equipment 8 according to the decision data to inhibit the pop-up window. In practice, when the decision data comprises the position coordinate and clicking location of the mouse, the processor 114 can establish the commands of mouse and keyboard according to the decision data to simulate the inputting of the mouse and keyboard of the equipment 8, thereby inhibiting the pop-up window of display device 81.

In the non-intrusive shared processing method and system for pop-up window of the present invention, the pop-up window of equipment is detected by the non-intrusive terminal device, and then it is determined if there is any solution existing for processing the current pop-up window. If the pop-up window is an unprocessed pop-up window, it would be published to the information theme of the communication interface. After that, the central processing device manually or automatically generates the decision data corresponding to the pop-up window, and publishes the decision data to the information theme in the communication interface. At last, the non-intrusive terminal device receives the decision data from the information theme in the communication interface, and inhibits or closes the pop-up window of equipment according to the decision data. Therefore, the non-intrusive shared processing method and system for pop-up window can automatically detect the pop-up window of the equipment, and the operators can remotely provide the solution through the communication interface, thereby reducing the labor costs. Moreover, the non-intrusive shared processing method and system for pop-up window of the present invention can also automatically inhibit the pop-up window of the equipment through the non-intrusive terminal device, thereby increasing the production efficiency.

In addition, the data transmission means of the non-intrusive terminal device and the central processing device can be other ways except those aforementioned. In one embodiment, when the non-intrusive terminal device and the central processing device subscribe to the same information theme, the communication interface directly connects the non-intrusive terminal device and central processing device with each other. When the non-intrusive terminal device publishes the pop-up window, the pop-up window data would be transmitted to the central processing device directly. In the same way, when the central processing device publishes the decision data, the decision data would be transmitted to the non-intrusive terminal device directly.

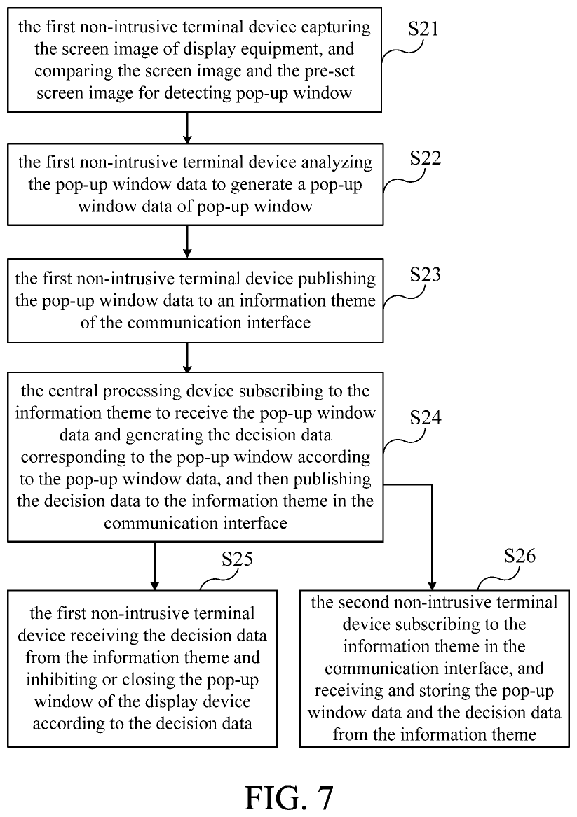

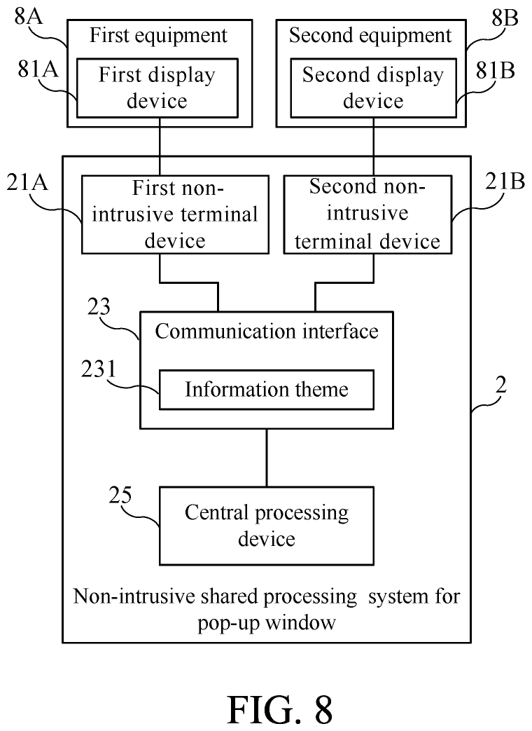

The non-intrusive shared processing system for pop-up window in FIG. 2 comprises only one non-intrusive terminal device. In practice, there may be a plurality of same equipments in the production line of the factory. Therefore, the non-intrusive shared processing system for pop-up window can also be the shared processing method for pop-up window among the plurality of non-intrusive terminal devices. Please refer to FIG. 7 and FIG. 8. FIG. 7 is a flow chart illustrating a non-intrusive shared processing method for pop-up window according to another embodiment of the present invention. FIG. 8 is a function block diagram illustrating a non-intrusive shared processing system 2 for pop-up window according to an embodiment of the present invention. The non-intrusive shared processing method for pop-up window in FIG. 7 can be implemented by the non-intrusive shared processing system 2 in FIG. 8. The non-intrusive shared processing system 2 for pop-up window of the present invention can be connected to the plurality of non-intrusive terminal devices for inhibiting the pop-up windows on the plurality of display devices of the equipments. As shown in FIG. 8, the difference between this embodiment and the above-mentioned embodiments is that the non-intrusive shared processing system 2 for pop-up window in this embodiment comprises a first non-intrusive terminal device 21A and a second non-intrusive terminal device 21B. Furthermore, the first non-intrusive terminal device 21A is connected to the first display device 81A of the first equipment 8A. The second non-intrusive terminal device 21B is connected to the second display device 81B of the second equipment 8B. The first equipment 8A and the second equipment 8B are the same equipment.

In this embodiment, the first non-intrusive terminal devices 21A, the second non-intrusive terminal devices 21B and the central processing device 25 all subscribe to the information theme 231 in the communication interface 23. As shown in the steps of FIG. 7, after the first non-intrusive terminal devices 21A analyzes and publishes the pop-up window data of the pop-up window and the central processing device 25 publishes the decision data corresponding to the pop-up window (step S21˜S24), not only the first non-intrusive terminal device 21A receives and stores the decision data for inhibiting the pop-up window of the first equipment 8A (step S25), but the second non-intrusive terminal device 21B also receives and stores the pop-up window data and the decision data from the information theme 231 (step S26). In practice, a plurality of same equipments may be set up in the factory for increasing the production volume. In other words, the same pop-up window may appear on the second equipment 8B as appearing on the first equipment 8A. Therefore, the second non-intrusive terminal device 21B can receives the type of the pop-up window appearing on the first device 8A and the corresponding solution through information theme 231 in the communication interface 23. Furthermore, the second non-intrusive terminal device 21B can comprise a second database. After the processor of the second non-intrusive terminal device 21B controls the transmission module to receive the pop-up window data and the decision data, the processor can store the pop-up window data and the decision data to the second database as the history pop-up window data and the history decision data. Therefore, the non-intrusive shared processing method and system for pop-up window can automatically transmit the pop-up window data and the corresponding solution to other equipments of the same type for reducing the processing time of the operators, improving efficiency and saving costs.

Similar, when the first non-intrusive terminal device 21A, the second non-intrusive terminal device 21B and the central processing device 25 all subscribe to the information theme 231, the communication interface 23 directly connects the first non-intrusive terminal device 21A, the second non-intrusive terminal device 21B and the central processing device 25 with each other. When the first non-intrusive terminal device 21A publishes the pop-up window data and the central processing device 25 publishes the decision data, the pop-up window data and decision data are also transmitted to the second non-intrusive terminal device 21B.

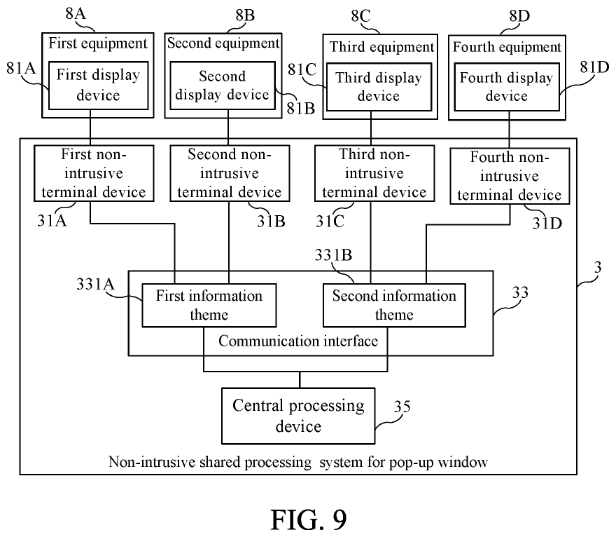

Please refer to FIG. 9. FIG. 9 is a function block diagram illustrating a non-intrusive shared processing system 3 for pop-up window according to another embodiment of the present invention. As shown in FIG. 9, the difference between this embodiment and the above-mentioned embodiments is that the non-intrusive shared processing system 3 for pop-up window in this embodiment comprises a first non-intrusive terminal device 31A, a second non-intrusive terminal device 31B, a third non-intrusive terminal device 31C and a fourth non-intrusive terminal device 31D. The first non-intrusive terminal device 31A is connected to the first display device 81A of the first equipment 8A. The second non-intrusive terminal device 31B is connected to the second display device 81B of the second equipment 8B. The third non-intrusive terminal device 31C is connected to the third display device 81C of the third equipment 8C. The fourth non-intrusive terminal device 31D is connected to the fourth display device 81D of the fourth equipment 8D. Furthermore, the communication interface 33 comprises a first information theme 331A and a second information theme 331B. The first non-intrusive terminal device 31A and second non-intrusive terminal device 31B subscribe to the first information theme 331A. The third non-intrusive terminal device 31C and fourth non-intrusive terminal device 31D subscribe to the second information theme 331B. The central processing device 35 subscribes to the first information theme 331A and the second information theme 331B.

In practice, the first equipment 8A and second equipment 8B can be the first type equipment, and the third equipment 8C and fourth equipment 8D can be the second type equipment. Although the type of the first equipment 8A and the second equipment 8B is different from that of the third equipment 8C and the fourth equipment 8D, the pop-up windows with the same type may appear on the first equipment 8A and the third equipment 8C. Therefore, after the first non-intrusive terminal device 31A publishes the pop-up window data to the first information theme 331A in the communication interface 33 and the central processing device 35 generates the decision data according to the pop-up window data, the central processing device 35 can also publish the pop-up window data and the decision data to the second information theme 331B in addition to publishing the decision data to the first information theme 331A. At this time, the third non-intrusive terminal device 31C can receive and store the pop-up window data and the decision data from the second information theme 331B. Similarly, the second non-intrusive terminal device 31B can receive and store the pop-up window data and decision data from the first information theme 331A, and the fourth non-intrusive terminal device 31D receive and store the pop-up window data and the decision data from the second information theme 331B. Therefore, the non-intrusive shared processing method and system for pop-up window makes the equipments with different types to process the pop-up windows with the same type through multiple information themes for reducing the processing time of the operators, improving efficiency and saving costs.

In addition, although the pop-up windows with the same type may appear on the first equipment 8A and the third equipment 8C, the first equipment 8A and third equipment 8C may need different solutions for the pop-up windows because they may comprise different parameters or thresholds. Therefore, the first non-intrusive terminal device 31A and third non-intrusive terminal device 31C can respectively publish the pop-up window data to the first information theme 331A and second information theme 331B, and the central processing device 35 respectively establish the pop-up window of the first equipment 8A and the pop-up window of the third equipment 8C. After that, the operators can respectively select the solutions suitable for the pop-up windows of the first equipment 8A and the third equipment 8C to generate the decision data. Finally, the central processing device 35 publishes the decision data respectively corresponding to the pop-up windows of the first equipment 8A and the third equipment 8C to the first information theme 331A and second information theme 331B. The first non-intrusive terminal device 31A and third non-intrusive terminal device 31C respectively receive the decision data from the first information theme 331A and second information theme 331B. Therefore, the non-intrusive shared processing method and system for pop-up window makes the equipments with different types to process the pop-up windows with the different types through multiple information themes for reducing the processing time of the operators, improving efficiency and saving costs.

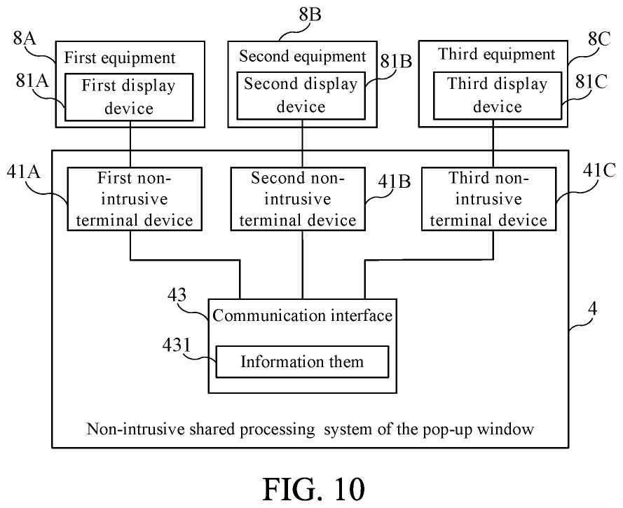

The decision data can be generated by other device in addition to the central processing device. Please refer to FIG. 10. FIG. 10 is a function block diagram illustrating a non-intrusive shared processing system 4 for pop-up window according to another embodiment of the present invention. As shown in FIG. 10, the difference between this embodiment and the above-mentioned embodiments is that the non-intrusive shared processing system 4 for pop-up window of this embodiment comprises a first non-intrusive terminal device 41A, a second non-intrusive terminal device 41B and a third non-intrusive terminal device 41C, but not comprises the central processing device. Furthermore, the first non-intrusive terminal device 41A is connected to the first display device 81A of the first equipment 8A. The second non-intrusive terminal device 41B is connected to the second display device 81B of the second equipment 8B. The third non-intrusive terminal device 41C is connected to the third display device 81C of the third equipment 8C. The first equipment 8A, the second equipment 8B, and the third equipment 8C are the equipments of the same type. In this embodiment, the first non-intrusive terminal device 41A, second non-intrusive terminal device 41B, and third non-intrusive terminal device 41C all subscribe to the information theme 431 in the communication interface 43. After the first non-intrusive terminal device 41A publishes the pop-up window data of the pop-up window, the third non-intrusive terminal device 41C receives the pop-up window data from the information theme 431 of the communication interface 43 to generate the decision data corresponding to the pop-up window, and publishes the decision data to the information theme 431 in the communication interface 43.

In practice, the operators can generate the decision data from the display device of the equipment. After the first non-intrusive terminal device 41A publishes the pop-up window data of the pop-up window, the processor of the third non-intrusive terminal device 41C can present the pop-up window data on the third display device 81C of the third equipment 8C. The operators can execute the processing through the mouse and keyboard of the third equipment 8C. At this time, the processor of the third non-intrusive terminal device 41C records the position coordinate of the mouse on the third display device 81C and the clicking location of the mouse for forming the decision data. And then, the processor of the third non-intrusive terminal device 41C controls the transmission module to publish the decision data to the information theme 431 of the communication interface 43. Furthermore, the first non-intrusive terminal device 41A receives the decision data from the information theme 431 in the communication interface 43 for inhibiting the pop-up window on the first display device 81A. In addition, the second non-intrusive terminal device 41B receives and stores the pop-up window data and the decision data from the information theme 431 of the communication interface 43. Therefore, the non-intrusive shared processing system for pop-up window can directly process the pop-up window on the equipment for increasing convenience and efficiency.

In summary, the non-intrusive shared processing method and system of the present invention can automatically detect the pop-up window of the equipment, and the operators can remotely provide the solution through the communication interface, thereby reducing the labor costs. In addition, the non-intrusive shared processing method and system for pop-up window of this invention can automatically inhibit the pop-up window generated by the equipment through the non-intrusive terminal device, thereby reducing the labor costs and increasing the production efficiency. Furthermore, the non-intrusive shared processing method and system for pop-up window of the present invention can automatically detect and compare the current pop-up window with the processed pop-up window through the storage device, thereby increasing the detecting efficiency and reducing the time costs. Moreover, the non-intrusive shared processing method and system for pop-up window of the present invention can automatically transmit the pop-up window data and the corresponding solution to the equipments of the same type by the way of subscribing/publishing, thereby reducing the processing time of the operators, increasing the efficiency and lowering the cost. In addition, the non-intrusive shared processing system for pop-up window of the present invention can directly process the pop-up window on the equipment, thereby increasing convenience and efficiency.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A non-intrusive shared processing method for pop-up window, configured for inhibiting or closing a pop-up window on a display device, the non-intrusive shared processing method for pop-up window comprising the following steps:
a first non-intrusive terminal device publishing a pop-up window data of the pop-up window to an information theme in a communication interface;
a central processing device subscribing to the information theme in the communication interface to receive the pop-up window data and generating a decision data corresponding to the pop-up window, and publishing the decision data to the information theme in the communication interface;
the first non-intrusive terminal device receiving the decision data from the information theme in the communication interface, and inhibiting or closing the pop-up window on the display device according to the decision data;
a second non-intrusive terminal device subscribing to the information theme in the communication interface; and
the second non-intrusive terminal device receiving and storing the pop-up window data and the decision data into a second database from the information theme of the communication interface.

2. The non-intrusive shared processing method for pop-up window of claim 1, further comprising the following steps:
the first non-intrusive terminal device capturing a screen image of the display device and detecting the pop-up window by comparing the screen image with a preset screen image; and
the first non-intrusive terminal device analyzing the pop-up window to generate the pop-up window data.

3. The non-intrusive shared processing method for pop-up window of claim 2, wherein the step of the first non-intrusive terminal device capturing the screen image of the display device and detecting the pop-up window by comparing the screen image with a preset screen image further comprises the follows steps:
the first non-intrusive terminal device capturing the screen image of the display device;
the first non-intrusive terminal device determining whether the preset screen image exists or not;
if the preset screen image does not exist, the first non-intrusive terminal device setting the screen image as the preset screen image; and
if the preset screen image exists, the first non-intrusive terminal device detecting the pop-up window by comparing the screen image with the preset screen image.

4. The non-intrusive shared processing method for pop-up window of claim 2, wherein the step of the first non-intrusive terminal device analyzing the pop-up window to generate the pop-up window data further comprises the following steps:
the first non-intrusive terminal device analyzing and calculating the pop-up window by an algorithm to generate a button data in the pop-up window data, wherein the button data comprises a button contour and a button position; and
the first non-intrusive terminal device analyzing the button data by Optical Character Recognition to generate a button character in the button data.

5. The non-intrusive shared processing method for pop-up window of claim 2, further comprising the following steps:
the first non-intrusive terminal device comparing the pop-up window data with a plurality of history pop-up window data stored in a first database to determine whether the pop-up window data conforms with a first history pop-up window data in the plurality of history pop-up window data, wherein the first database stores a plurality of history decision data, and the plurality of history pop-up window data are respectively corresponding to the plurality of history decision data; and
if the pop-up window data conforms with a first history pop-up window data, the first non-intrusive terminal device inhibiting or closing the pop-up window according to the history decision data corresponding to the first history pop-up window data.

6. The non-intrusive shared processing method for pop-up window of claim 1, wherein the step of the central processing device subscribing to the information theme in the communication interface to receive the pop-up window data and generating a decision data corresponding to the pop-up window, and publishing the decision data to the information theme in the communication interface further comprises the following steps;
the central processing device receiving the pop-up window data to generate a plurality of solutions corresponding to the pop-up window data;
selecting one of the solutions as the decision data according to the pop-up window data of the pop-up window; and
the central processing device publishing the decision data to the information theme in the communication interface.

7. (canceled)

8. A non-intrusive shared processing system for pop-up window, configured to inhibit or close a pop-up window of a display device, the non-intrusive shared processing system for pop-up window comprising:
a communication interface comprising an information theme, wherein the information theme is configured to store a pop-up window data of the pop-up window and a decision data corresponding to the pop-up window data;
a first non-intrusive shared terminal device coupled to the communication interface and the display device and subscribing to the information theme of the communication interface, and the first non-intrusive shared terminal device further comprising:
an image capturing module, configured to capture a screen image of the display device;
an image analyzing module, coupled to the image capturing module and storing a preset screen image, wherein the image analyzing module is configured for analyzing the screen image and the preset screen image, so as to detect the pop-up window and generate the pop-up window data;
a transmission module, configured to publish the pop-up window data to the information theme and receive the decision data from the information theme; and
a processor, coupled to the transmission module and the display device, wherein the processor is configured to control the transmission module to publish the pop-up window data and to receive the decision data, and the processor can inhibit or close the pop-up window of the display device according to the decision data; and
a second non-intrusive terminal device coupled to the communication interface and subscribing to the information theme of the communication interface, the second non-intrusive terminal device comprising a second database, the second non-intrusive terminal device being configured to receive the pop-up window data and the decision data from the information theme, and store the pop-up window data and the decision data into the second database.

9. The non-intrusive shared processing system for pop-up window of claim 8, wherein the first non-intrusive terminal device comprises a first database coupled to the processor, the first database is configured to store the plurality of the history pop-up window data and the plurality history decision data, the history pop-up window data respectively corresponds to the history decision data when the image analyzing module generates the pop-up window data conforming with a first history pop-up window data in the plurality of the history pop-up window data, and the processor can inhibit or close the pop-up window of the display device according to the history decision data corresponding to the first history pop-up window data.

10. (canceled)

11. The non-intrusive shared processing system for pop-up window of claim 8, further comprising a central processing device coupled to the communication interface and subscribing to the information theme of the communication interface, the central processing device receiving the pop-up window data from the information theme to generate the decision data corresponding to the pop-up window, and publishing the decision data into the information theme of the communication interface.

12. The non-intrusive shared processing system for pop-up window of claim 11, wherein the central processing device generates the plurality solutions corresponding to the pop-up window data according to the pop-up window data, and uses one of the solutions selected by a user as the decision data.

13. The non-intrusive shared processing system for pop-up window of claim 11, wherein the central processing device comprises an analyzing module, the central processing device generates the plurality solutions corresponding to the pop-up window data according to the pop-up window data, and the analyzing module according to pop-up window data selects one of the solutions as the decision data.

14. The non-intrusive shared processing system for pop-up window of claim 10, further comprising a third non-intrusive terminal device coupled to the communication interface and subscribing to the information theme of the communication interface, wherein the third non-intrusive terminal device receives the pop-up window data from the information theme for generating the decision data corresponding to pop-up window, and publishes the decision data into the information theme of the communication interface.

15. The non-intrusive shared processing system for pop-up window of claim 8, wherein the image analyzing module sets the screen image as the preset screen image when the preset screen image does not exist.

16. The non-intrusive shared processing system for pop-up window of claim 8, wherein the image analyzing module analyzes the pop-up window to generate a button data of the pop-up window data by an algorithm and Optical Character Recognition, wherein the button data comprises a button contour, a button position, and a button character.
